(19) United States
(12) Patent Application Publication
(10) Pub. No.: US 2006/0038370 A1
(43) Pub. Date: Feb. 23, 2006

(54) Method of controlling a vehicle wheel suspension

(76) Inventors: Ernst-Ludwig Doerr, Stuttgart (DE); Wolfgang Ruedt, Benningen (DE); Kenji Shinoda, Stuttgart (DE); Hans-Gerhard Spindler, Fellbach (DE)

Correspondence Address: KLAUS J. BACH, 4407 TWIN OAKS DRIVE, MURRYSVILLE, PA, 15668, US

(21) Appl. No.: 11/238,662

(22) Filed: Sep. 29, 2005

Related U.S. Application Data
(63) Continuation-in-part of application No. PCT/EP04/03099, filed on Mar. 24, 2004.

(30) Foreign Application Priority Data
Mar. 29, 2003 (DE) 103 14 251.7

(51) Int. Cl. B60G 21/045; B60G 21/055

(52) U.S. Cl. 280/124.106; 280/5.506

(57) ABSTRACT

In a method for controlling the wheel suspension of a motor vehicle having an anti-roll bar for a front axle, an anti-roll bar connected to a rear axle, at least one sensor, one control unit and a circuit including an operating medium with a supply reservoir, a directional control device and an actuator for each anti-roll bar with each actuator being assigned a particular section of the circuit, different sections of the circuit are in control of different actuators so as to be actuated in opposite directions to one another as a function of vehicle operating conditions, in order to improve the traction of the vehicle on uneven underlying surfaces.

This is a Continuation-In-Part Application of International Application PCT/EP2004/003099 filed 24 Mar. 2004 and claiming the priority of German application 103 14 251.7 filed 29 Mar. 2003.

### BACKGROUND OF THE INVENTION

The invention relates to a method of controlling a vehicle wheel suspension including front and rear axle anti-roll bars and a device for carrying out the method.

It is known to use anti-roll bars to improve the driving behavior in motor vehicles. When the vehicle leans for example during cornering the anti-roll bars are subjected to torsion in order to counteract rolling movements of the vehicle. Such a system is known from laid-open patent application DE 43 37 765 A1.

Patent DE 42 37 708 C1 discloses a device for influencing rolling movements of a vehicle. The device has anti-roll bars which can be controlled as a function of the spring compression of the wheel by means of actuators. Each actuator is assigned a non return valve arrangement which protects the actuator against the hydraulic medium being forced back to the pressure source. The valves are controlled by means of an electronic control device. From the signals of the sensors, the control device generates an actual value signal for the rolling angle of the body of the vehicle relative to the underlying surface. This actual value signal is low-pass filtered. A signal for controlling the valves is formed from the filtered actual value signal by comparison with a set point value. The actuators are actuated by means of the valves in such a way that a torque which acts on the body of the vehicle with respect to the longitudinal axis of the vehicle is generated. Here too, as the anti-roll bar is subject to torsion rolling movement of the vehicle is counteracted. On an even underlying surface, this has a favorable effect on the driving behavior of the vehicle. However, the traction capability of the vehicle may be impaired on an uneven underlying surface.

It is the object of the invention to provide a method with which the traction of a vehicle on an uneven underlying surface can be improved during cornering, and to provide a device for carrying out the method.

### SUMMARY OF THE INVENTION

In a method for controlling the wheel suspension of a motor vehicle having an anti-roll bar connected to a front axle, an anti-roll bar connected to a rear axle, at least one sensor, one control unit and a circuit including an operating medium with a supply reservoir, a directional control device and an actuator for each anti-roll bar in which each actuator is assigned a particular section of the circuit, different sections of the circuit are in control of different actuators so as to be actuated in opposite directions to one another as a function of vehicle operating conditions in order to improve the traction of the vehicle on an uneven underlying surface.

In this way, it can be ensured that all the wheels of the vehicle are always subjected to approximately the same loading. As a result, differences of wheel loads of the vehicle wheels are reduced and the traction of the vehicle is increased.

The actuators are preferably continuously actuated. The position of the actuators is thus continuously adapted to changes in the underlying surface. As a result, the movements of the body of the vehicle on an uneven underlying surface are reduced. This results in softer vehicle movements and a greater degree of driving comfort. The method is particularly suitable for slow travel on uneven terrain.

The invention will become more readily apparent from the following description of a preferred embodiment thereof shown, by way of example only, in the accompanying drawings.

### BRIEF DESCRIPTION OF THE DRAWINGS

FIG. 1 is a schematic illustration of a preferred active chassis according to the invention,

FIG. 2 is a schematic illustration of the forces and actuating travel values at the axles of a preferred active chassis,

FIG. 3 shows a preferred embodiment of a signal processing diagram for a method according to the invention,

FIG. 4 shows results of a torsion test on a passive chassis,

FIG. 5 shows results of the torsion test on a chassis with an open anti-roll bar,

FIG. 6 shows results of the torsion test on a chassis with an active off-road function,

FIG. 7 shows a preferred embodiment of a hydraulic system according to the invention,

FIG. 8 shows an alternative embodiment of the hydraulic system according to the invention,

FIG. 9 shows a variant of the hydraulic system according to FIG. 8, and

FIG. 10 shows a preferred embodiment of the hydraulic system with non return devices which are arranged parallel to one another in the subsections of the circuits.

### DESCRIPTION OF A PARTICULAR EMBODIMENT

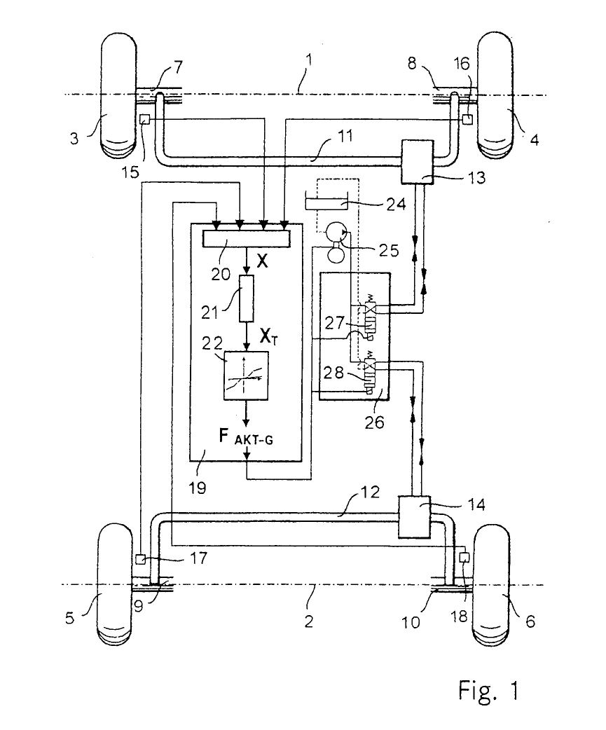

FIG. 1 is a schematic view of a preferred active chassis of a motor vehicle. Two vehicle wheels 3 and 4 are arranged on a front axle 1 and two vehicle wheels 5 and 6 are arranged on a rear axle 2. Each vehicle wheel 3, 4, 5 and 6 is rotatably mounted on a wheel carrier 7, 8, 9 and 10. Here, the vehicle wheel 3 is assigned the wheel carrier 7, the vehicle wheel 4 is assigned the wheel carrier 8, the vehicle wheel 5 is assigned the wheel carrier 9 and the vehicle wheel 6 is assigned the wheel carrier 10. The wheel carriers 7, 8, 9, 10 are moveably attached to a body of a vehicle (not illustrated). The distance between a vehicle wheel 3, 4, 5 or 6 and the body of the vehicle which can be varied by means of a moveable wheel carrier 7, 8, 9 or 10 is referred to as a spring travel value n_{LV}, n_{RV}, n_{LH} and n_{RH}. Here, the indices: V=front axle, H=rear axle, L=left-hand, R=right-hand. The wheel carriers 7 and 8 of the front axle 1 are connected to one another by means of a common anti-roll bar 11. The wheel carriers 9 and 10 of the rear axle 2 are connected to one another by means of a common anti-roll bar 12.

The anti-roll bars 11, 12 are embodied in FIG. 1 as round bars which are bent in a U shape with a base section and two side limbs projecting from it. The side limbs of the anti-roll bars 11, 12 are each connected to a wheel carrier 7, 8, 9, 10. The anti-roll bars 11, 12 are rotatably mounted on the body of the vehicle.

The anti-roll bars 11, 12 transmit movements and forces from one vehicle wheel 3, 5 to the other vehicle wheel 4, 6 and vice versa. When there are differences between the spring travel of the left-hand vehicle wheel 3, 5 and that of the right-hand vehicle wheel 4, 6 of one axle 1, 2, restoring forces F_{STAB-V} or F_{STAB-H} are produced in the anti-roll bar 11, 12 and attempt to reduce the differences between the spring travel values n_{RV}−n_{LV} and n_{RH}−n_{LH}.

For reducing rolling movements when cornering motor vehicles are usually equipped with an anti-roll bar. During cornering, restoring forces which counteract the rolling of the body of the vehicle are produced owing to differences in wheel travel. When cornering on an even underlying surface this property of the anti-roll bars is favorable.

On an uneven underlying surface, anti-roll bars amplify the differences between the wheel loads at the individual axles. An uneven underlying surface is present if the four wheel contact points do not lie in one plane. In such a case, traction capability of the vehicle is reduced if the wheel loads are distributed unevenly owing to this tension. This tension is generated by the spring suspension at each individual vehicle wheel and is amplified by the additionally installed anti-roll bars.

The conflict in objectives between the dynamic movement properties of the vehicle (for example rolling movements when cornering) and the torsion capability for off-road travel cannot be solved with previously known methods.

Likewise, the conflict in objectives described above cannot be solved with passive chassis because a reduction in the rolling angle when cornering, for example due to an increase in the rigidity of the anti-roll bars, results in worsening of the off-road riding characteristics.

For example, on an uneven underlying surface the vehicle wheel 3 of the front axle 1 is loaded on one side. As a result that side limb of the anti-roll bar 11 which is assigned to this vehicle wheel 3 pivots and the entire anti-roll bar 11 is subject to torsion. This torsion of the anti-roll bar 11 causes that side limb of the anti-roll bar 11 which is assigned to the vehicle wheel 4 to follow this movement. At the same time, as a result of the torsion of the anti-roll bar 11 a restoring force F_{STAB-V} which is opposed to the torsion is applied on the side limbs which are assigned to the vehicle wheels 3 and 4. This restoring force F_{STAB-V} results from the twisting of the anti-roll bar 11 owing to the difference in spring travel between the left-hand and right-hand vehicle wheels 3 and 4 on the front axle 1. It acts in the sense of a reduction in the difference in spring travel in the opposite direction to the torsion. In the case of an idealized perpendicular spring travel of the axles 1, 2, the anti-roll bars 11, 12 generate essentially vertical forces F_{STAB-V}, F_{STAB-H} which are considered here. When an anti-roll bar 11 is guided at its bearing point in a way which is virtually free of friction, the resulting force at the left-hand vehicle wheel 3 and at the right-hand vehicle wheel 4 is the same in absolute terms. The force F_{STAB-V} which acts on the two vehicle wheels 3, 4 of the front axle 1 via the anti-roll bar 11 is dependent on the stiffness c_{V} of the anti-roll bar 11 and the spring travel n_{LV} and n_{RV} of the two vehicle wheels 3 and 4 to the left and right of the anti-roll bar 11 and can be calculated using
F_{STAB-V}=(n_{RV}−n_{LV}). C_{V},
where n_{RV}−n_{LV}=e_{V} is referred to below as anti-roll bar torsion e_{V} which corresponds to the horizontal distance between the vehicle wheels 3 and 4 which is brought about by the torsion of the anti-roll bar 11. In the considered case of an anti-roll bar without an actuator, this corresponds to the difference between the spring travel values n_{LV} and n_{RV} of the left-hand and right-hand vehicle wheels 3 and 4 of the front axle 1. The variable distance between the vehicle wheel 3, 4 and body of the vehicle is referred to as spring travel n_{LV} and n_{RV}.

By analogy, the following
F_{STAB-H}=(n_{RH}−n_{LH}). C_{H} where n_{RH}−n_{LH}=e_{H}
applies to the force F_{STAB-H} which the anti-roll bar 12 of the rear axle 2 transmits between the two vehicle wheels 5 and 6 of the rear axle 2.

The anti-roll bars 11, 12 which are illustrated in FIG. 1 are active anti-roll bars. As active anti-roll bars, the anti-roll bars 11 and 12 each have an actuator 13 or 14 for actively controlling the transmission of force between the two vehicle wheels 3 and 4 of the front axle 1 and the two vehicle wheels 5 and 6 of the rear axle 2. The actuators 13, 14 may be embodied as mechanical, electrical or hydraulic actuating elements. In principal energy can be supplied in any desired way, but is preferably supplied hydraulically.

The actuator 13, 14 can change the forces transmitted between the vehicle wheels 3, 4 and 5, 6, respectively, of one axle 1, 2 by the anti-roll bar 11, 12. The actuator 13, 14 does not have any direct bearing points on the vehicle body and is basically supported on the anti-roll bar. Consequently, the forces F_{AKT-V} and F_{AKT-H} are applied by the actuator 13, 14 on the left and right of the two points of attachments for the anti-roll bars 11, 12 on the wheels are virtually the same in absolute terms if acceleration and friction forces are ignored.

The actuators 13, 14 of the two axles 1, 2 are able to transmit both positive and negative actuating forces F_{AKT-V}, F_{AKT-H} and thus support a change in sign and direction from F_{V}, F_{H} on both sides of the vehicle. Furthermore, each actuator 13, 14 is capable of applying both positive and negative actuator movements s_{V}, s_{H} with respect to its neutral base position. These actuator movements s_{V}, S_{H} are not directly coupled to the force F_{V}, F_{H} which is transmitted simultaneously to the vehicle wheels 3, 4, 5, 6 because the actuator movements s_{V}, s_{H} also additionally depend on the differences between the spring travel values between the vehicle wheels 3, 4 and 5, 6 of the associated axle 1 or 2, respectively. Therefore, the following applies to the front axle 1
e_{V}+s_{V}=n_{RV}−n_{LV}
F_{V}=cᵥ*eᵥ=cᵥ*(n_{RV}−n_{LV}−s_{V})
And by analogy to the rear axle 2
e_{H}+s_{H}=n_{RH}−n_{LH}
F_{H}=c_{H}*e_{H}=c_{H}*(n_{RH}−n_{LH}−S_{H})

In order to bring about the off-road function according to the invention, each actuator 13, 14 is adjusted in such a way that the force which is transmitted by the associated anti-roll bar 11, 12 to the vehicle wheels 3, 4 and 5, 6 assigned to it has a different sign in a steady state than in the neutral position of the actuator 13, 14 (s=0, i.e. locked actuator or actuator not present) and when there are identical spring travel values at the two vehicle wheels 3, 4 or 5, 6 on an axle 11 or 12, respectively.

A further feature of the invention is that the forces F_{V}, F_{H} which act on the vehicle wheels 3, 4 and 5, 6 via anti-roll bars 11 and 12 have opposite signs on the front and back on one side of the vehicle.

In order to be able to adjust the actuators 13, 14 in accordance with the differences in spring travel at the two axles 1, 2, the differences between the spring travel values must be acquired and converted into a control operation of the actuators 13, 14. According to the invention, as illustrated in FIG. 1, four spring travel sensors 15, 16, 17, 18 are provided for sensing the spring travel values of the four vehicle wheels 3, 4, 5, 6. Alternatively, other sensors which can be used to acquire the differences between the spring travel values may also be provided. The signals of the sensors 15, 16, 17, 18 are fed to a control unit 19 which generates a control signal for controlling a circuit. The actuator 13 of the anti-roll bar 11 and the actuator 14 of the anti-roll bar 12 are connected to the circuit. The actuators 13 and 14 have pressure applied to them via the circuit in accordance with the control signal of the control unit 19. At each of the actuators 13, 14, the pressure acting on the actuators 13, 14 brings about an actuating force F_{ACT-V}, F_{ACT-H} or an actuator movement s_{V}, s_{H}.

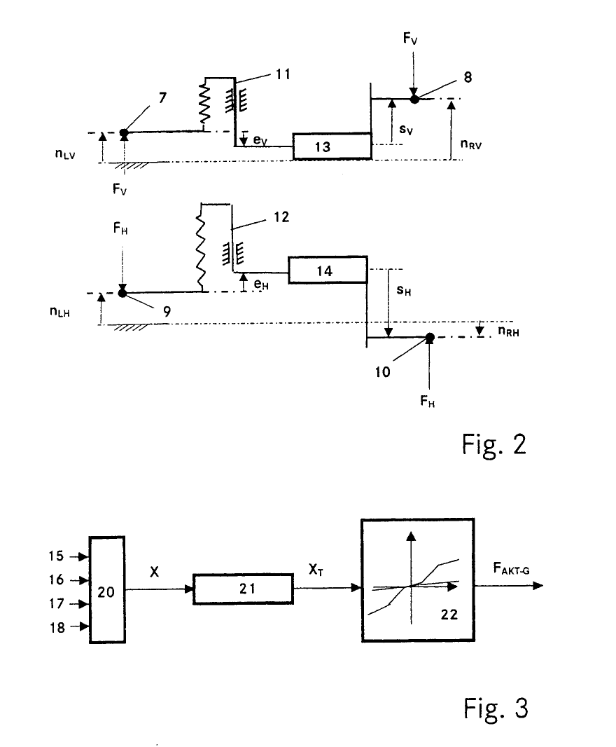

FIG. 2 shows by way of a example a schematic illustration of the forces F_{V}, F_{H}, the spring travel values n_{LV}, n_{RV}, n_{LH}, n_{RH}, the actuator movements s_{V}, s_{H} and the anti-roll bar torsion values e_{V}, e_{H} to the axles 1, 2 of an active chassis according to the invention. An active anti-roll bar 11 of a front axle 1 and an active anti-roll bar 12 of a rear axle 2 are illustrated. The anti-roll bars 11, 12 are illustrated schematically as spring components which are attached to the body of the vehicle in a vertical moveable fashion. The surfaces which are fixed to the body of the vehicle are represented by hatching. The dot-dash lines from which the anti-roll bar torsion values e_{V}, e_{H} are measured characterize the position of the anti-roll bars 11, 12 which is neutral in terms of force and at which the anti-roll bar torsion values e_{V} and e_{H} is zero, and n_{LV} is equal to n_{RV}, or n_{LH} is equal to n_{RH}. The actuators 13, 14 are integrated into the anti-roll bar 11, 12. They are not connected to the body of the vehicle. The connections of the anti-roll bars 11, 12 to the wheel carriers 7, 8, 9, 10 are illustrated as black dots.

In the case illustrated in FIG. 2, the positive spring travel difference n_{RV}−n_{LV} at the front axle 1 brings about a positive force F_{V}. As a result of the strong movement s_{V} of the actuator 13 in the positive direction, overall a negative e_{V} is produced, which then corresponds to a negative force F_{V}.

For the rear axle 2, the same applies but in inverted fashion. Because n_{RH}−n_{LH} has a different sign in a steady state than n_{RV}−n_{LV}, a correspondingly positive reacting force F_{H} is actively generated as a result.

If other control components are zero (for example lateral acceleration, steering wheel angle, sum of the axle rolling angle), F_{V} and F_{H} change the sign precisely when X=n_{RV}−n_{LV}−n_{RH}+n_{LH} changes its sign.

F_{V} and F_{H} do not necessarily need to be of equal magnitude in absolute terms. Only if all the other control components and actuating instructions of the controller are zero (for example spring travel open-loop/closed-loop control or acceleration open-loop/closed-loop control) and none of the system has yet reached the physical stop, it is appropriate to make the forces at the front and at the rear the same in absolute terms.

In order to actuate the actuators 13, 14 of the front axle 1 and rear axle 2, according to FIG. 1 a circuit with a supply reservoir 24, a pump unit 25 and an actuating device 26 with non return devices 27, 28 is provided. The actuators 13, 14 are part of this circuit. The direction and the force with which the actuators 13, 14 are actuated can be controlled using the circuit.

In this context it is important for the circuit to permit the actuator movement sv of the front axle 1 and the actuator movement s_{H} of the rear axle 2 to have a different sign in the direction of force/adjustment (for example positive at the front and negative at the rear as illustrated in FIG. 2).

The open-loop and/or closed-loop control of the circuit is carried out by means of the control unit 19. This control unit 19 receives the signals from the sensors 15, 16, 17, 18 and, in a method illustrated in FIG. 3, converts them into a control signal for performing open-loop and/or closed-loop control of the circuit.

FIG. 3 shows the method which is carried out by the control unit 19 and which generates the off-road functions according to the invention and is described below. Firstly, it is helpful to know the movements of the wheel positions with respect to the body of the vehicle in the Z direction, that is to say the 4 spring travel values n_{RV}, n_{LV}, n_{RH}, n_{LH}, or the two differences between the spring travel values n_{RV}−n_{LV} and n_{RH}−n_{LH} for the front axle 1 and the rear axle 2.

The sensors 15, 16, 17, 18 serve to sense the spring travel values n of the vehicle wheels 3, 4, 5, 6. The sensors 15, 16, 17, 18 are embodied, for example, as four high level sensors which are arranged in the vicinity of the wheel. Alternatively, it is possible to use all the conceivable sensors and combinations of sensors which can be used to determine the differences between the spring travel values of the vehicle wheels 3, 4, 5, 6. The signals of the sensors 15, 16, 17, 18 for the distance n between the vehicle wheel 3, 4, 5, or 6 and the body of the vehicle are fed to a control unit 19 according to FIG. 1.

If the spring travel values n are not sensed by sensors 15, 16, 17, 18, they can be estimated by measuring the forces F_{V}, F_{H} and the actuator movements s_{V}, s_{H}.

For example, the spring travel difference between the vehicle wheels 3 and 4 of a front axle 1 can be estimated from the actuator movement s_{V} of the actuator 13 and the force F_{V} which acts from the chassis at the vehicle wheels 3 and 4 as well as a spring constant c_{V} of the anti-roll bar 11, using
n_{RH}−n_{LV}=F_{V}/c_{V}+s_{V}.

Analogously, in order to estimate the difference between the spring travel values n of the vehicle wheels 5 and 6 of the rear axle 2 using an index H for the rear axle 2 the following formula is obtained:
n_{RH}−n_{LH}=F_{V}/C_{H}+S_{V}.

When the vehicle tracks of the front axle 1 and rear axle 2 are different, the corresponding lever ratios should be converted in such a way that the overall torque which acts on the vehicle is as far as possible zero. This compensation of different track widths of the front axle 1 and rear axle 2 is carried out by means of a normalization factor N which is to be selected. If the track widths of the front axle 1 and of the rear axle 2 are the same, the normalization factor is N=1.

In the method step 20, a value
X=N*(n_{RV}−n_{LV})−n_{RH}+n_{LH}
is acquired from the differences between the spring travel values n of the vehicle wheels 3, 4, 5, 6 and the normalization factor N.

This value X is a measure of how the four vehicle wheels 3, 4, 5, 6 are in relation to one another and thus in relation to the unevenness of the underlying surface.

In one embodiment, this result signal X is smoothed by a low-pass filter 21 and radio-frequency signals are removed from it. The damping movements between the chassis and vehicle body remain. The new, smoothed signal is designated by X_{T}. As is shown by FIG. 3, after low-pass filtering of X to produce X_{T}, this X_{T} can refer to a Characteristic curve diagram.

In a further favorable refinement, a Characteristic curve diagram 22 is applied to the smoothed signal X_{T} which is coupled to the information about the current position of the actuators 13, 14. According to the invention, the Characteristic curve diagram 22 can take into account further parameters. For example, the velocity of the vehicle or the position of operator control switches can be taken into account. In this context, the Characteristic curve diagram 22 assigns a force F_{AKT} to be applied and a sign to the X_{T} value.

In this context, a positive X_{T} value means that the front actuator 13 is actuated in such a way that the force between the vehicle wheel 3 and the body of the vehicle on the left is increased and the force between the vehicle wheel 4 and the body of the vehicle on the right is reduced, and that the rear actuator 14 is actuated in such a way that the force between the vehicle wheel 5 and body of the vehicle on the left is reduced and the force between the vehicle wheel 6 and body of the vehicle on the right is increased. Given a negative X_{T} value, the actuators are actuated precisely the other way round.

In one embodiment according to the invention, it is determined which actuator movement has to be generated for the required forces to be applied to the vehicle wheels 3, 4, 5, 6.

In one favorable embodiment, an actuating force F_{AKT-G} is calculated for each actuator 13, 14, and in each case an actuating direction for the actuator 13 and 14 with which the wheel load differences are reduced is calculated.

In one favorable development, other control components can be added to the force F_{AKT-G} to be applied. For example it is possible to combine the result of a rolling stabilization process or settings for a sporty or comfortable chassis with calculated force F_{AKT-G}. In this context, a super position of a plurality of control components can lead to a situation in which the actuators 13, 14 are actuated in the same direction at certain times.

The actuating force from the off-road function F_{AKT-G} is then obtained with
F_{AKT-V}=F_{AKT-G}*N+F_{XV} ( . . . ) and
F_{AKT-H}=F_{AKT-G}*N+F_{XH} ( . . . )
the actuating forces which can be closed-loop or open-loop controlled at the respective actuator. F_{XV} and F_{XH} indicate that for the total force to be applied control components which fulfill other control functions can also be added here for each actuator (super position principle). This procedure is in principle possible without the objective of minimizing the difference between the wheel loads being lost.

The active off-road function is particularly preferably used at very low travel speeds or at stand-still. The requirement for traction is at its greatest particularly in these situations.

In pressure supply systems or power supply systems which can generate and control different forces in terms of direction but only identical forces in terms of absolute value per axle in a steady-state fashion, the actuating force derived from the off-road function F_{AKT-G} where
F_{AKT-V}=F_{AKT-G} and
F_{AKT-H}=F_{AKT-G}
is to be equated in all cases in terms of absolute value. In this case, the independent addition of other control components would also no longer be possible in this case.

As an alternative to a force control, the force F_{AKT} to be applied can also be converted into an actuator movement s to be applied for travel control. The movement path is then sensed and it is determined when the actuator movement s to be applied has been achieved.

If the actuators are open-loop/closed-loop travel controllers instead of open-loop/closed-loop force control means, the set point forces which have already been calculated and the directly or indirectly determined sensor signals n_{R}−n_{L} can be used to calculate the actuator movements S_{AKT} to be applied with
s_{V}=n_{RV}−n_{LV}−F_{AKT-V}/c_{V} and
s_{H}=n_{RH}−n_{LH}−F_{AKT-H}/c_{H}.
The actuator movements s to be applied are then transferred to the actuators.

The characteristic curve is to be preferably dimensioned using the maximum/minimum force of the actuator and the maximum and minimum actuator movement.

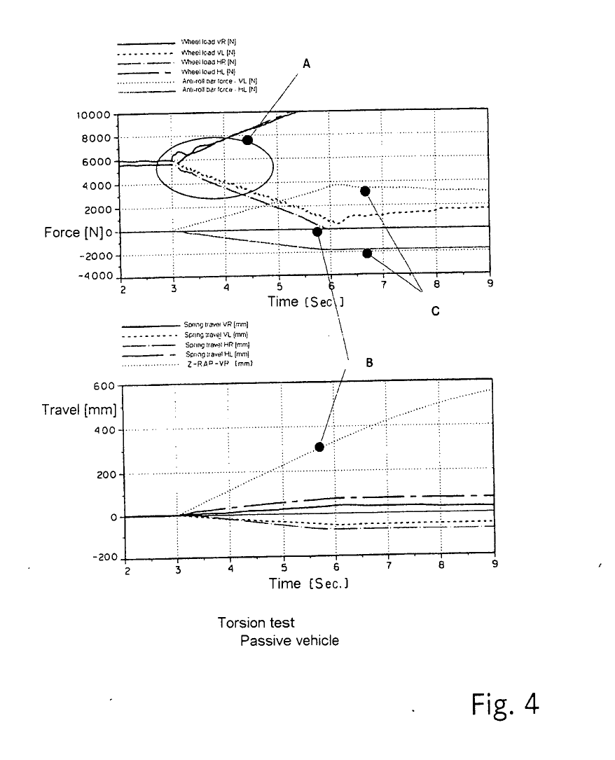

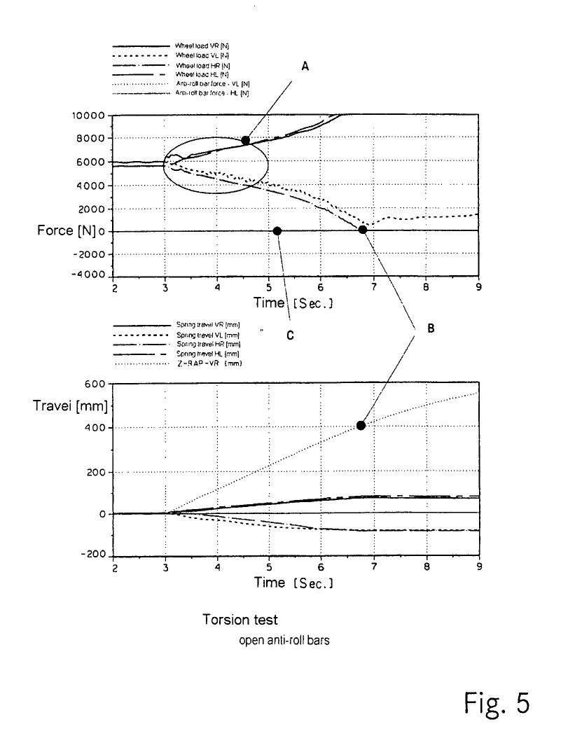

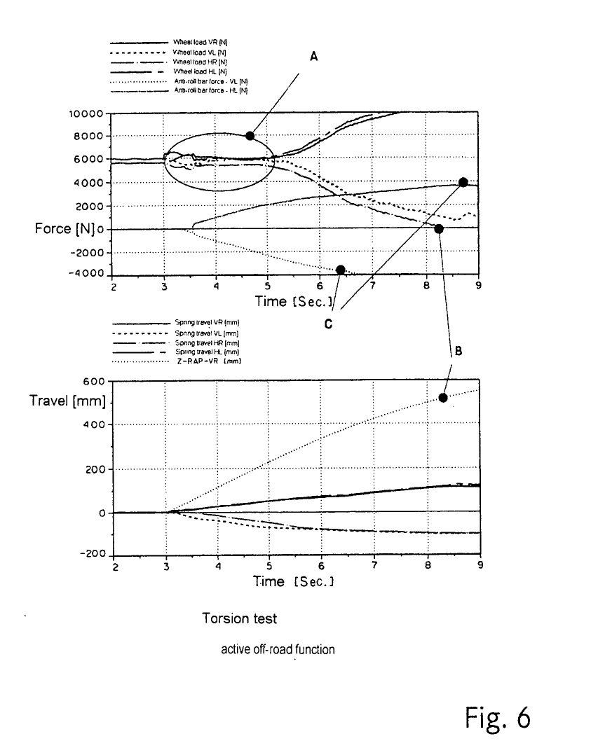

FIG. 4 to FIG. 6 show results of a body twist test. A “slow” twist test, i.e. a quasi-static twisting, with a very stiff body structure and with an average load is illustrated. In the stationary state, when the engine is running in order to supply pressure, the right-hand vehicle wheel 4 of the front axle 1 is slowly loaded (moved in the direction of spring compression) by means of a hydraulic pulse plunger. FIG. 4 shows the results of the twist test on a passive chassis, FIG. 5 shows the results of the twist test on a chassis with open anti-roll bars 11, 12, and FIG. 6 shows the results of the torsion test on a chassis according to the invention with an active off-road function.

For this purpose, in an off-road vehicle, a wheel suspension according to the invention with anti-roll bars 11, 12 which are relatively rigid compared to customary anti-roll bars and which have approximately 50 N/mm mutual spring stiffness was implemented. Rotary hydraulic motors of a maximum ±34 degrees swivel angle were used as actuators 13, 14. Also, longitudinally operating motors acting directly on the lever arm of the anti-roll bars 11, 12 would be conceivable. The generated torque corresponds to approximately 1300 Nm when there is a 150 bar pressure difference.

FIG. 4 to FIG. 6 each show two graphs illustrating the test results. In the lower graph, the displacement path of the plunger Z-RAP-VR is placed alongside the acquired spring travel values n at the individual vehicle wheels (spring compression illustrated positively) plotted over time. Matching this, in the upper graph the anti-roll bar forces which are exerted by the anti-roll bars 11, 12 are placed alongside the wheel loads plotted against time. Positively represented anti-roll bar forces on the left at the front and on the left at the rear each have wheel load reducing effect or spring compression effect on the left-hand wheel side, and vice versa on the right. Areas of the graphs which are to be particularly noted, are characterized by the letters A, B and C and are explained in more detail below.

FIG. 4 shows the test with a passive system and unmodified anti-roll bar stiffness values. As can be seen in region A, changes in wheel load start immediately when the torsion starts. Given an approximately 330 mm plunger travel, a vehicle wheel 6 of the rear axle 2 lifts off. At this time, the wheel load at this vehicle wheel 6 is zero. The passively generated forces of the anti-roll bars 11, 12 have, as is apparent from the two curves marked by C, a positive direction at the front and a negative direction at the rear with respect to the wheel contact point.

FIG. 5 shows the same test with opened anti-roll bars at the front and at the rear. The two curves which are marked by C for the anti-roll bar forces at the front and at the rear are correspondingly zero over the entire course of the test. As is apparent in region A, the changes in wheel load also start immediately here when the torsion starts. These changes in the wheel load result from the suspension of the body of the vehicle. The lifting off of a rear wheel at point B does not take place until at approximately 400 mm.

FIG. 6 then shows the torsion test with active anti-roll bars 11, 12 with an active off-road function. What is characteristic of the active off-road function in the sense of this invention is that on the two curves marked by C for the anti-roll bar forces the signs of the anti-roll bar forces point in a different direction compared to the test with a passive system (locked motors). The advantages are apparent from two features:
Even with average torsion values there is a large traction advantage because, as is apparent in region A, the wheel loads can be kept almost constant over a large torsion range.
The lifting off of a rear wheel at point B does not take place until at approximately 515 mm displacement travel of the plunger.

The specified example may simultaneously be used as a measuring procedure for determining whether or not a vehicle has an active off-road function. The criteria which is specified under FIG. 6 and the comparison with the passive system (motor locked or bypassed) must give the sign reversal of the anti-roll bar forces and significantly improve the wheel load profiles plotted against the torsion.

The maximum torsion of a motor vehicle can then be increased by orders of magnitude depending on the configuration of the actuator system and of the passive vehicle. As a result, the vehicle gains a large degree of additional traction capability. Traction aids such as electronic stability programs, traction controllers or locking differentials may be activated at a later point or they may be completely dispensed with. The traction and torsion capability constitute an important benchmark and purchase criterion, in particular for vehicles which are capable of off-road operation.

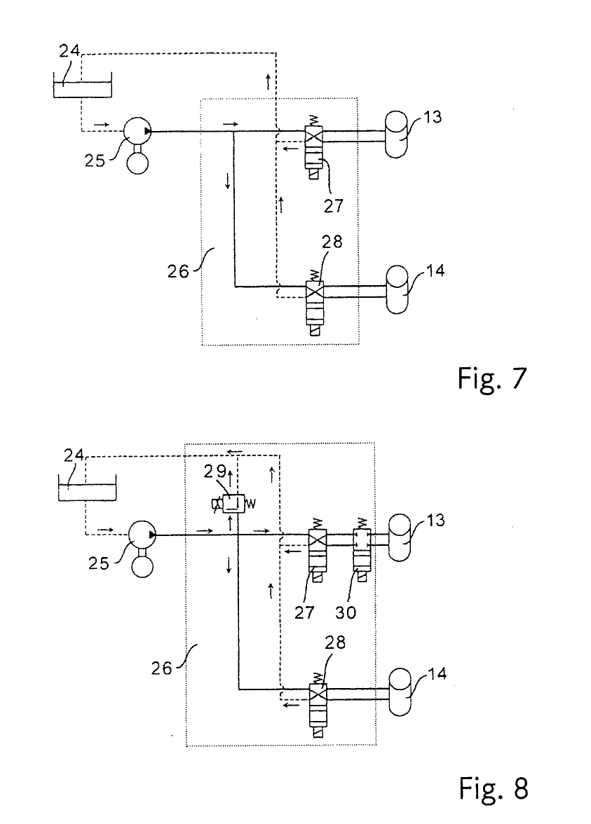

In order to transmit the control signals to actuator movements, the invention provides a circuit which activates the actuators 13 and 14. Such circuits are illustrated in FIG. 7 to FIG. 10. Such a circuit has a supply reservoir 24 for a hydraulic medium which is connected via a pump unit 25 to an actuator 13 for an anti-roll bar 11 of a front axle 1, and to an actuator 14 for an anti-roll bar 12 of a rear axle 2. Downstream of the pump unit 25, the circuit divides for this purpose into two subsection circuits which are arranged parallel to one another. In this context, each subsection of a circuit is assigned to one of the actuators 13, 14. Each of the subsections of a circuit, contains one of these actuators 13 or 14 and the non return devices 27, 30, 32, 34 and 28, 31, 33, 35 which are assigned to this actuator 13 or 14. This design of the circuit has the advantage that, when a subsection of a circuit fails, the other subsection is still operational. The non return devices 27, 30, 32, 34 and 28, 31, 33, 35 are combined in one actuating device 26. The direction of flow of the actuating medium is characterized by arrows in FIG. 7 to FIG. 10.

FIG. 7 shows a simple possible form of such a circuit. In one preferred embodiment, this circuit has a supply reservoir 24 for a hydraulic medium which is connected to an actuator 13 for an anti-roll bar 11 of a front axle 1 via the pump unit 25 and via a direction non return device 27. In the reverse direction, the actuator 13 is directly connected to the supply reservoir 24 via the direction non return device 27. Between the pump unit 25 and the direction non return device 27, the circuit branches to a further direction non return device 28 which is connected to an actuator 14 for an anti-roll bar 12 of a rear axle 2. In this way, the same pump pressure is present at both actuators 13, 14. In the reverse direction, the actuator 14 is also connected to the direction non return device 28. The return lines of the two directional control valves 27, 28 are combined for the return of the control fluid to the supply reservoir 24.

In this context, according to the invention the pump unit 25 and the directional control valves 27, 28 of the circuit which are combined in the actuating device 26 are actuated in accordance with the actuating values which are calculated by the control unit 20.

The pump unit 25 receives the signal to build up the system pressure for an actuator force F_{AKT} to be applied. The directional control valves 27 of the front axle 1 receives a signal to switch to the open position if F_{AKT} is assigned a positive sign and to switch to reverse the flow direction if F_{AKT} is assigned a negative sign.

In contrast, the directional control valve 28 of the rear axle 2 receives a signal to switch to the open position if F_{AKT} is assigned a negative sign and to reverse the flow direction if F_{AKT} is assigned a positive sign. As a result, the actuator 13 of the front axle 1 and the actuator 14 of the rear axle 2 are actuated with the same system pressure but with a reversed flow direction.

In FIG. 7 to 10, the subsections of the circuits are arranged parallel to one another in relation to the direction of flow of the operating medium. If one of the subsections of the circuits fails, the other subsection is nevertheless still functional.

As illustrated in FIG. 8, in a further embodiment at least one circuit section has a blocking device 30. This blocking device 30 serves as protection against failure of the directional reversing valve 27 and/or of the pump unit 25. The blocking device 30 locks the actuator 13 in a position when the directional control valve device 27 fails and/or when the pressure fails. The anti-roll bar 11 can then still operate as a non-active anti-roll bar despite the failure of the actuator 13. For this reason, such a directional reversing valve 27 is preferably provided in the circuit section which is assigned to the steered front axle 1.

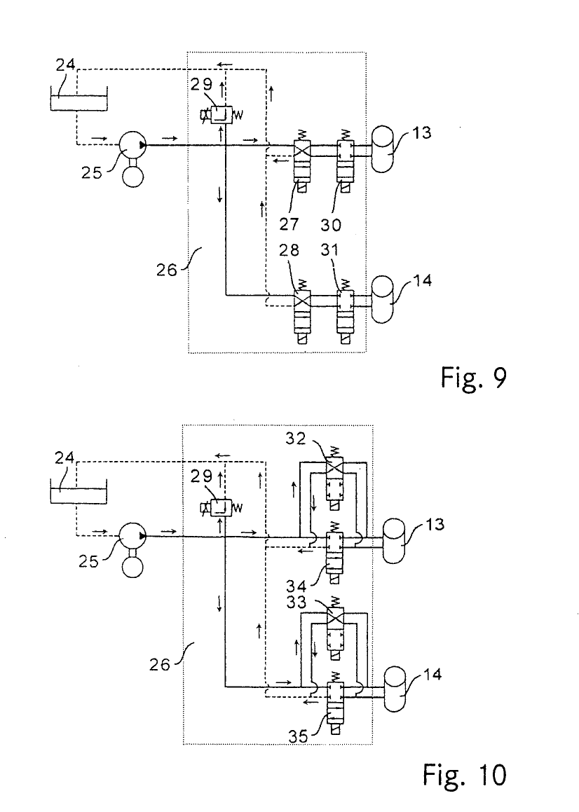

FIGS. 8 and 9 show circuits in which the directional control valves 27, 30 and 28, 31 which were assigned to an actuator 13, 14 are serially arranged with respect to one another in relation to the direction of flow of the actuating medium which is characterized with arrows in FIGS. 8 and 9. In this context, in the illustrated form one non return device is embodied as a directional control valves 27, 28 and the other as a blocking valve 30, 31. FIG. 8 shows an embodiment in which only one circuit section is equipped with a blocking valve device 30. In FIG. 9, both circuit sections are provided with a blocking valve 30, 31. In such circuits with blocking valves 30, 31 it is also possible to use the control unit 19 to actuate only one actuator 13, 14 and to lock the other actuator 14, 13 at the same time.

In a further advantageous embodiment, a pressure limiter 29 which is arranged between the output end of the pump unit 25 and the supply reservoir 24 is provided, as is illustrated by means of various embodiments in FIGS. 8 to 10. The object of the pressure limiter 29 is to limit the maximum pressure present at the actuator 13, 14. If a higher pressure is present at the pressure limiter 29 than the maximum pressure defined by the control unit 19, the pressure limiter 29 opens and pressurized fluid is discharged to the supply reservoir 24. As the pressure drops again below the maximum pressure set, the pressure limiter 29 closes. The maximum pressure can be freely adjusted at the pressure limiter 29. The setting of the maximum pressure at the pressure limiter 29 is controlled by the signal processing means or control unit 19. The system pressure is set by means of the pressure limiter 29. In systems without a pressure limiter 29 the system is set by means of the pump unit 25.

In the embodiment, the pressure limiter 29 is part of the pump unit 25.

FIG. 10 shows a circuit in which the control valves 32, 34 and 33, 35 which are assigned to an actuator 13, 14 have a parallel arrangement with respect to one another in relation to the direction of flow of the actuating medium. Each of the directional control valves 32, 33, 34, 35 has a blocking position. In this context, in the illustrated form, in each subsection which is assigned to an actuator 13, 14 one directional control valve is embodied as a directional control valve 32, 33 and the other as a blocking valve 34, 35.

In the embodiments illustrated in FIG. 7 to FIG. 10, a single common system pressure is open-loop or closed-loop controlled. A circuit which is constructed in such a way restricts the actuation possibilities of the actuators 13, 14 with respect to one another but is cost effective.

In another embodiment, the system pressure for each subsection can be open-loop or closed-loop controlled separately. For example, each subsection of the circuit is supplied with its own variable system pressure via a flow divider. As a result, it is possible to control the actuators 13, 14 in a very differentiated fashion over a wide range.

In one preferred embodiment, the actuating medium for the circuit is a hydraulic fluid. For example, the supply reservoir 24 is embodied as a hydraulic fluid reservoir, the pump unit 25 as a motor pump unit and the actuating device 26 as a valve block. This valve block typically has directional control valves 27, 28, a pressure limiting valve 29 and blocking valves 30, 31. It is possible, for example, to use a hydraulic swivel motor or a hydraulic actuation arm as the actuator 13, 14.

In a further embodiment, the actuating medium for the circuit is compressed air. For example, the supply reservoir 24 is embodied as a compressed air supply, the pump unit 25 as a compressor and the actuating device 26 as a pneumatic valve block. This valve block typically has directional control valves 27, 28, pressure limiting valves 29 and blocking valves 30, 31. Compressed air controlled or hydro-pneumatic actuators are suitable as actuators 13, 14.

In an alternative embodiment, the actuating medium for the circuit is electric current. For example, the supply reservoir 24 is embodied as a battery, the pump unit 25 as a generator and the actuating device 26 as a circuit board. This circuit board typically has directional switches 27, 28, transistors 29 and on/off switches 30, 31. For example a control motor is provided as the actuator 13, 14.

What is claimed is:

1. A method for controlling the wheel suspension of a motor vehicle having front and rear axles (1, 2), an anti-roll bar (11) connected to the front axle (1) and an anti-roll bar (12) connected to the rear axle (2) and comprising:
at least one sensor (15, 16, 17, 18),
a control unit (19),
a control circuit, including an operating medium,
an operating medium reservoir (24),
a directional flow control valve (27), and for each
anti-roll bar (11, 12),
an actuator (13, 14) for applying a force to the anti-roll bar (11, 12)
each actuator (13, 14) being supplied with operating medium from a section of the control circuit, said sections of the control circuit which are assigned to the actuators (13, 14) being actuated in opposite directions to one another as a function of motor vehicle operating conditions.

2. The method as claimed in claim 1, wherein an X signal is determined from signals of the sensors (15, 16, 17, 18) as a measure of unevenness of positions of the vehicle wheels (3, 4, 5, 6), assigned to the front axle and the rear axle, with respect to the vehicle body.

3. The method as claimed in claim 2, wherein the X signal is smoothed by means of a low-pass filter (21).

4. The method as claimed in claim 2, wherein the X signal is evaluated by means of a characteristic curve diagram (22).

5. The method as claimed in claim 2, wherein a force which is to be applied to the anti-roll bar is calculated from the X signal and a position of the actuators (13, 14) for each actuator (13, 14), with which differences of wheel loads of the vehicle wheels (3, 4, 5, 6) are reduced.

6. The method as claimed in claim 1, wherein a system pressure of the circuit is controlled by one of an open-loop and a closed-loop control.

7. The method as claimed in claim 6, wherein a separate system pressure is controlled by one of an open-loop and closed-loop control for each subsection of the circuit.

8. The method as claimed in claim 5, wherein at least one of closed-loop control components and a wheel suspension setting are added to the force to be applied.

9. The method as claimed in claim 8, wherein closed-loop control components of a rolling stabilization means are added to the force to be applied.

10. The method as claimed in claim 1, wherein the force to be applied is converted into an actuator movement to be carried out in order to control the travel of the actuator (13, 14).

11. A device for carrying out a method for controlling the chassis of a motor vehicle having a first anti-roll bar (11) which is assigned to a front axle (1) and a second anti-roll bar (12) which is assigned to a rear axle (2), each having at least one sensor (15, 16, 17, 18), a control unit (19) and having a circuit with an operating medium, a supply reservoir (24), a directional control valve (27, 28), and first and second actuators (13, 14) for said first and second anti-roll bars (11, 12), respectively, with each actuator (13, 14) being assigned a subsection of the circuit, said device comprising:
a pump unit (25) connected to the first actuator (13) for the first anti-roll bar (11) of the front axle (1) via a directional control valve (27), and
the pump unit (25) being connected to the second actuator (14) for the second anti-roll bar (12) of the rear axle (2) via a further directional control valve (28), so that the same pump pressure is present at both actuators (13, 14),
said first and second actuators (13, 14) having return lines which are combined and connected to the supply reservoir (24).

12. The device as claimed in claim 11, wherein the subsections of the circuits are arranged parallel to one another with respect to the direction of flow of the actuating medium.

13. The device as claimed in claim 11, wherein at least one subsection of a circuit has a blocking valve (30, 31).

14. The device as claimed in claim 11, wherein a pressure limiter (29) is provided which is arranged between the output end of the pump unit (25) and the supply reservoir (24).

15. The device as claimed in claim 13, wherein the control and blocking valves (27, 30) and (28, 31) which are assigned to the first and second actuator (13, 14) have a serial arrangement with respect to one another in relation to the direction of flow of the actuating medium.

16. The device as claimed as claimed in claim 13, wherein blocking and control valves (27, 30) and (28, 31) which are assigned to the actuators (13, 14) have a parallel arrangement with respect to one another in relation to the direction of flow of the actuating medium.

17. The device as claimed in claim 11, wherein the operation medium is a hydraulic fluid.

18. The device as claimed in claim 11, wherein the actuating medium is compressed air.

19. The device as claimed in claim 11, wherein the actuating medium is an electric current.
